(19) United States
(12) Patent Application Publication
(10) Pub. No.: US 2014/0205269 A1
(43) Pub. Date: Jul. 24, 2014

(54) V-CDRTpersonalize/personalized methods of greeting video(audio,DVD) products production and service

(71) Applicant: Changyi Li, Reston, VA (US)

(72) Inventor: Changyi Li, Reston, VA (US)

(21) Appl. No.: 13/747,501

(22) Filed: Jan. 23, 2013

(51) Int. Cl. G11B 27/00

(52) U.S. Cl. CPC G11B 27/00
USPC 386/285

(57) ABSTRACT

My this invention patent is called V-CDRT personalize/personalized methods of greeting video (audio, DVD) products production and service. The V-CDRT products production service are showed and provided on/via network system (internet system), media system (television and radio system) and any commercial market/place. V-CDRT is a world-wide and unique methods and principle and operation and idea and manner for video/audio products production and service in history in the fields of software engineering technology; related science fields; social circles, entertainment industry, and commercial industry.

Application number: (a). provisional patent application No. 61/633,442; filing date: Feb. 13, 2012. (b). non-provisional patent application Ser. No. 13/747,501; filing date: Jan. 23, 2013.

### CROSS REFERENCE TO RELATED THE APPLICATION

(a). This nonprovisional application should be benefited from the provisional application, the application No. 61/633,442 ; the confirmation number:7785

(b). The drawing of V-CDRT is on the page 25; Abstract of disclosure is on the page 21; Claim is on the page 22; Amendment is on the page 18 and page 19; Change of correspondence address is on the page 20.

(c). This application also include date sheet, declaration, transmittle letter.

### BRIEF SUMMARY OF THE INVENTION

My this invention patent is called V-CDRT, the symbol of the patent is attached along with the application. It is the methods, principle and operation and manner and ideas of production and service for personalize/personalized greeting video, greeting audio, greeting DVD and related greeting products. The V-CDRT products are showed and provides via network/internet system, media system(television, radio media) and any commercial market place. It is a world-wide and unique video/audio products production and service in commercial history.

### BACKGROUND OF THE INVENTION

(a). Field of the Invention

This invention is used in fields of high technolog; commercial market; network and media system; entertainment field.

(b). Related Fields to the Invention

software engineering; entertainment; art; music; dance; astronomy; history; geography; literature; international culture; health care; psychology; diplomacy; business; smart ideas in living; drama; biology advertisement; science; finance; medical science; thalassology; architecture.

### DESCRIPTION OF THE INVENTION

V-CDRT is the methods, principle and idea of production and service for the products of personalize/personalized greeting video, greeting audio, greeting DVD and related products. Based on the invention patent V-CDRT, all rights are reserved for all the power of control for the activities such as related research, development, trade, commercial ideas which related to the same or similar idea to this invention patent V-CDRT. the production and service are showed and provided and represented via network system (internet), media system (television and radio system, and any commercial market/place. How do the invention patent V-CDRT work? In the network (internet) system and media system (television and radio system), and the DVD products, the personalize/personalized greeting video/audio, greeting DVD products call and show the specific person's (company's) name which client want to put the name on it and along with brief greeting message to make artistic short MTV like video/audio, or advertisement like artistic video/audio into these multiple type of products:

(a). for video products: Create specific person's (or company's) name and brief Greeting message into the song's lyrics along with any of the following video background and view: artists music performance (singing and/or dance); short game; interesting cartoon performance program; high technology special effects; short interesting or funny movie like story; short advertisement like artistic video; The source of these programs for these conceptions and stories and songs in the video are from these fields: space science (asfronomy); history; medical; biology geography; literature; international culture; art; psychology; music; dance; drama; diplomacy; business; smart idea in living; concept of entertainment; concept of commerce; thalassology; architecture; science; finance; science;

(b). For audio products: Create specific person's (or company's) name and brief greeting message into the song's lyrics along with any of the following audio background: singing performance; interesting speech program; high technology special audio effects; short interesting and/or funny audio story performance; short advertisement like artistic audio. The source of these programs for these conceptions and stories and music songs are from these fields: asfronomy; music; history; geography; literature; international culture; psychology; medical science; diplomacy; concept of business; concept of entertainment; concept of commerce; drama; smart idea in living. thalassology; architecture; science; finance; science. Create brief video and/or audio greeting message program along with any of above programs and stories and backgrounds with showing and/or calling person's name or company's name and client's interested messages become the V-CDRT products.

Two kind of examples of the V-CDRT products:

(1). V-CDRT Products for People:

Example for “Happy birthday” V-CDRT video:

The video begins to start: a beautiful view of nature shows, and a group of beautiful people with many birthday gifts come out, they sing and dance, they sing:” Happy birthday to Mary . . . (here, they call the specific person's name in the program), it's like a short artistic MTV, any of the roles show in the video may (or may not) plays as the role that client want to indicate. The lyrics and greeting messages text show on the video. The background and the view from the video can be designed into any one of above artistic and interesting programs. V-CDRT for people include: birthday celebration; friendship greeting; marriage celebration; family love greeting; couple love greeting; couple fun message; single's wishes; party invitation; people's dream; people's hope/wishes; ask help from public; joke and fun; look for friends; find match; greeting entertainment.

(2). V-CDRT Products for Company/Entity Clients:

Example for a chocolate company's “Hello, my clients” V-CDRT video:

The video begins to start: a beautiful heaven like chocolate park show up with music, it's like a beautiful view of mythology: mountains, rivers, trees, flowers, all natures are made of chocolate, then many beautiful angels come out, dance and sing the company's name as the lyrics like this: “Hello, everyone, Chocolate Angels (here, they call the company's name) are singing for you.”

V-CDRT products for company and any entity, organization, group include: celebration event; greet to the clients from the company; greet to people from the company; greet to public from the company; announcement from the company for their new products; announcement from the company for their news and plans.

I am the invention patent V-CDRT original inventor. All rights reserved. V means victory of V-CDRT invention patent, and also V means all rights reserved to have power of controls to all the methods, and principle, and the operation, and the manner and idea, and activities of development and production to/from the V-CDRT invention patent such as related activities: research, and production, and development, and commercial trade that involve same or similar methods, and developmentbased on and to/from this V-CDRT invention patent. C means all rights reserved to have power of the controls to the activities of network and media system and computer software programs that are involved and related same or similar methods and development based on and to/from this V-CDRT invention patent. C also means computer/network.

D means all rights reserved to have the power of controls to all the activities of DVD productions that are involved and related same or similar methods and Development based on and to/from this V-CDRT invention patent. D also means DVD products.

R means all rights reserved to have power of controls to all the activities of radio media program that are involved and relate same or similar methods and manner based on and to/from this V-CDRT invention patent. R also means radio media. T means all rights reserved to have power of controls to television programs that are involved and related same or similar methods and manner based on and to/from this V-CDRT invention patent. T also means television media system.

V-CDRT products category include:

For people(individual client): “Birthday celebration”; “Friendship greeting”; “Marriage celebration”; “Family love greeting”; “Sweet love”; “Couple fun”; “Single's wishes”; “Party invitation”; “My dreams”; “People's wishes and hopes”; “Ask help from public”; “Just for fun”; “Looking for friends”; “Match center”; “Thank you so much”; “Health wishes”; “Student home”; “Career club”; “Just relax”; “Mystery and miracle”; “Fiction”; “Future scientists”; “Financial advisor”; “Story club”; “Smart idea for living”; “Time-space tunnel”; “News center”; “Magic virtual travel bus”.“Magic beautify”; “Oh, my baby”.

For companies , entities, organizations, groups: “Company's celebration”; “Greet to people from the company”; “Greet to clients from the company”; “Announcement to public from the company for the new products”; “Announcement to public from the company for their news or new plans”

### DESCRIPTION OF THE DRAWING

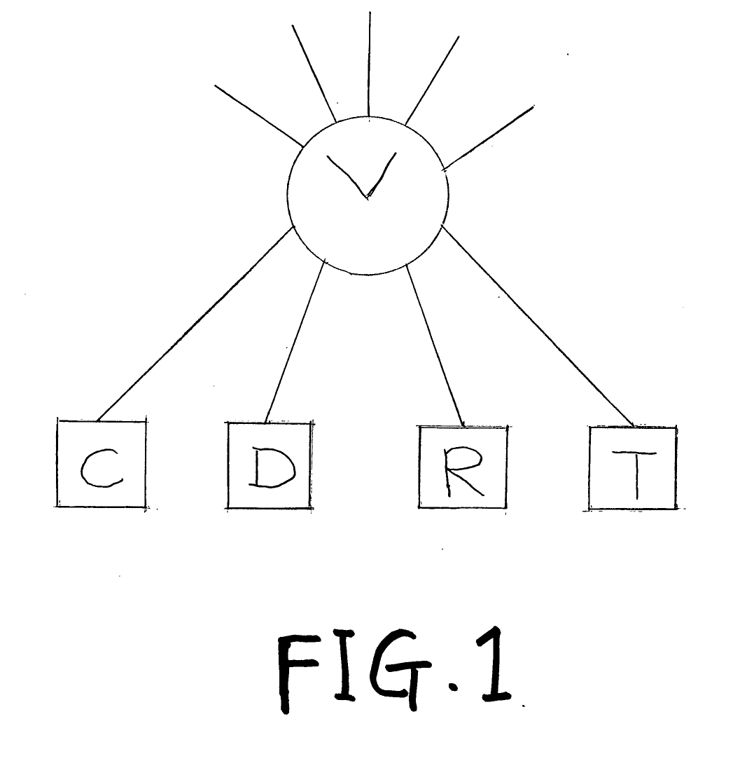

The drawing of the invention patent is show as “FIG.1”. Only one page of drawing for this application.

I claim:

1. The invention patent for V-CDRT personalize/personalized methods of Greeting video (audio, DVD) products production and service as show.
